(19) United States
(12) Patent Application Publication
(10) Pub. No.: US 2002/0138412 A1
(43) Pub. Date: Sep. 26, 2002

(54) System for risk and cost analysis in financing export transactions

(76) Inventor: Joseph G. Englert, San Francisco, CA (US)

Correspondence Address: Thomas M. Freiburger, 650 California Street, 25th Floor, San Francisco, CA, 94108, US

(21) Appl. No.: 09/816,023

(22) Filed: Mar. 23, 2001

(51) Int. Cl. G06F 17/60

(52) U.S. Cl. 705/38; 705/39

(57) ABSTRACT

A method and system for planning and estimating costs of an export transaction includes provision and use of a series of forms for orderly entry of information concerning the exporter, they buyer, the transaction, financing tools to be selected, for gathering costs for each of a number of financing alternatives, for evaluating risks and for calculating a total cost ratio of costs as compared to the entire transaction amount. The forms include work sheets to assist the lending officer or the exporter in evaluating risks, and for evaluating the total transaction based on all risk and cost information collected and analyzed, to the point of entering these data in a solution work sheet which displays the information in a simple and comprehensive format allowing the user to create an appropriate finance solution. The system also includes comparison of actual costs, as they come in, against the projected costs estimated in the virtual transaction.

### BACKGROUND OF THE INVENTION

The invention concerns financing of export transactions. More particularly, the invention is a system, including forms and a method, for giving the lender or exporter/customer a structured procedure in analyzing the risk and cost of, and planning the financing of an export transaction, from initial inquiry of the transaction to purchase order through final payment by the buyer/importer. The system also helps inform the user, in the initial planning stage, whether the transaction should be pursued. At the conclusion of a transaction, this system provides for comparison of projected costs against actual costs.

Financing of export transactions by lending institutions has often been an unstructured procedure, without a firm notion or estimate in advance of the total of all the various pre-export and post-export risks and costs of the financing. This is because the lending officer or the exporter usually does not gather together and plan each of the risk elements and various costs which might be associated with the transaction, including costs incident only to the particular transaction and structural costs which have a portion attributable to the transaction but which actually apply to a number of transactions. Typically the lending officer is not in possession of the requisite “tools”, including forms for the orderly gathering and entry of information, for risk analysis and for the calculation of various costs throughout the projected time duration of the export transaction, both pre-export and post-export. Some of these “tools” include detailed lists of financial tool options which can be used to finance both the pre-export and post-export portions of the transaction, and a risk evaluation template, along with price sheets for various selectable financing tools, and cost analysis and cost ratio work sheets that enable the lending officer (or the exporter) to fully analyze all risks and costs to the customer/exporter as well as revenue portions to the lending institution. Quite often the lending officer is not actually aware of the total revenue the lender will derive from the transaction, or the total cost ratio of financing costs against total transaction amount. Because of this transactions are often entered into when, if all the costs and revenue figures had been known, the transaction would have been avoided.

### SUMMARY OF THE INVENTION

The invention described herein encompasses a method and system for analyzing a trade transaction, particularly an export transaction, between a buyer and a seller to identify the terms of the transaction, risk factors, time cycle, finance requirement, potential financing tools and costs; and for setting forth a framework for providing an optimal financing plan cost measurement. It also provides a method and system for monitoring and managing the transaction costs.

An important aspect of the system is that costs of financing are analyzed as either structural or transaction costs, and are computed as a percentage of the transaction invoice amount, i.e. as a percentage of transaction amount. This total cost ratio is an important factor in evaluating the transaction, both for the customer/exporter and for the lending officer, creating an export management mechanism for analyzing and/or revising the transaction if the total cost ratio reveals distortion as compared to average costs for export transactions. It is also an important tool for monitoring and controlling actual costs.

The Trade “T” in this system is a timeline highlighting three points: (1) purchase order date (2) shipment date, and (3) final payment date. The purchase order date is the date the transaction is entered into and becomes real. At this point the exporter has an order in hand and the need for financing is realized. As of the shipment date, the transaction changes its nature. The performance risk-of the exporter usually passes at this point, the collateral changes from inventory of the seller to an account receivable, and the payment risk of the buyer is now primary.

The system of the invention fully recognizes these above factors and provides forms (either on paper or in computer software as pages on the computer screen) that enable the lending officer or the exporter to gather and assemble the proposed transaction information quickly and effectively by using essentially a four-step process, including a special financial tool box and a cost analysis process as the foundation for creative finance solutions.

Export transaction financing differs from many other types of loans and includes the following three aspects:

(1) The loan is granted against specific collateral that is germane to the transaction itself.

(2) The loan is self-liquidating. It does not have monthly or quarterly payment schedules.

(3) Transaction collateral is specific to the transaction and is monitored closely throughout the transaction term until payment. The collateral actually changes its nature during that term from inventory, such as material, work in progress, or finished goods, to accounts receivable upon shipment.

The system of the invention can be described as comprising four steps, for which preprinted forms (this term is intended to describe computer forms as well as paper forms herein), are provided as follows:

A: Inquiry Sheet

B: Risk Evaluation Sheet

C: Solution Work Sheet

D: Accepted Finance Plan

In addition, the overall system preferably includes a later comparison of actual costs against virtual (projected) costs, thus the following:

E: Comparison of Actual to Virtual Costs

For the transaction inquiry sheet of step A, the lending officer enters all pertinent information, including the identity of the exporter, description of the exporter's business and experience, particularly with exporting, information regarding the transaction, including the buyer and other transaction-specific information, the payment method and the estimated finance needed, including the amount and time of any loan against the transaction.

The lending officer then performs step B, by entering information on a risk evaluation sheet or form. Risk factor categories include the following: Pre-export, post-export, transaction, payment, finance, performance, shipment and final payment.

Once all risks have been entered onto the form, the lending officer begins to enter information in step C, the solution work sheet. First, finance tools are selected to fit the transaction, both pre-export tools and post-export tools. These are also selected in accordance with whether the financing will be short term (generally less than one year) or medium term (over one year). The user consults a financial “tool box” which is provided with the system and which includes sources of working capital for the pre-export period and sources of financing for the post-export period. The various sources of working capital include, for example, cash in advance, government sponsored programs, and trading companies. Post-export sources of financing can be selected from cash in advance, letters of credit, documentary collection instruments, open account, or factoring.

In using the financial “tool box”, the lending officer enters information in tool box price sheets, a form being provided for each of pre-export and post-export, and different forms can be provided for short term or medium term post-export.

These sheets or forms provide the framework for analyzing the costs of each possible financial tool on the basis of structural and transaction costs and lender revenue. This is a key part of the system of invention.

After entering information into these price sheet forms and performing needed calculations, the lending officer utilizes a cost analysis sheet or form to enter all projected structural costs, both pre-export and post-export and including lender revenue which comprises a part of those costs; and enters appropriate information as to transaction costs, again categorized by pre-export and post-export and broken down as to the lender revenue part of these costs.

Shipment allocation costs are also entered, on the same breakdown basis. The costs are totaled as to exporter costs and lender revenue, although included, is broken out separately.

The cost ratio work sheet is used to convert the information entered on the cost analysis sheet to ratios that become the basis for monitoring and managing costs in the transaction.

Once all this information has been entered, the work sheets have been completed and the lender has reviewed the projected result, including total cost ratio and lender revenue, the lending officer enters appropriate information to complete the solution work sheet of step C. The solution work sheet is used to evaluate the total transaction based on all of the risk and cost information collected and analyzed up to this point. It displays this information in a simple, comprehensive format that allows that lending officer to create an appropriate finance solution. This includes an itemization of the structural costs and the transaction costs of the overall transaction, and the entry of a total cost ratio as noted above. It also includes a final risk assessment specifically addressing the areas of exporter performance, shipment, and payment.

Finally, after the lender makes a proposal to the customer/exporter based on the various financial tools selected and the projected cost of the transaction, if the exporter/customer accepts this proposal, the lender goes to step D, an accepted finance plan. Information is entered onto another form, again divided into pre-export and post-export, listing purchase order documents, finance tools to be used, action steps along a time line and other pertinent information to the projected transaction. This can become a term sheet as a basis of the agreement between the lender and the customer/exporter.

It should be understood that the exporter/customer can perform these steps and present offered terms to the lender. References herein to “lender” or “lending” officer should be taken to apply to the exporter/customer as well, unless specifically stated otherwise.

It is therefore among the objects of the described invention to aid the lender or the exporter in analyzing and planning the financing of export transactions by providing a structured system for entry of pertinent information, for assessing all risks, for selection of appropriate financing tools for the particular transaction and for projecting an orderly series of events and action steps, to arrive at known costs, both structural and transactional, and to provide a total cost ratio for reference of the lender as well as the customer. The system brings to the forefront a number of factors and costs which might not otherwise be considered as the lender and the customer enter into an export financing transaction. These and other objects, advantages and features of the invention will be apparent from the following description of a preferred embodiment, considered along with the accompanying drawings.

### DESCRIPTION OF THE DRAWINGS

FIG. 1 is a schematic flow chart showing steps involved in the system in process of the invention.

FIG. 2 is a representation of a form which can be paper or generated in a computer, for a first step or step A of the system of the invention.

FIG. 3 is a view showing another form associated with a second step, or step B of the system.

FIG. 4 is another similar view showing a solution worksheet associated with another step of the system, step C.

FIG. 5 is a similar view showing a list of financial tools for financing export transactions.

FIGS. 6, 7 and 8 show three sheets of a form for entering prices of financial tools, covering pre-export and post-export.

FIG. 9 is another view showing a form for entry of information, in this case a cost analysis sheet.

FIG. 10 shows a form for entering information in a cost ratio work sheet.

FIG. 11 is a view showing a form for entry of information as an accepted financial plan, as a step D in the system of the invention.

FIG. 12 is another form, for an actual loan/collateral journal.

FIG. 13 shows a form for actual transaction cost review, for short term transactions.

FIG. 14 shows a form similar to FIG. 13, in this case for actual transaction cost review in a medium term transaction.

FIG. 15 shows a form for actual cost ratio comparison, making a comparison between the projected costs and cost ratio in the virtual transaction, to the actual costs and ratio of the completed transaction.

FIG. 16 is a flow diagram showing the projected or virtual transaction, progressing into the actual transaction, and showing use of many of the forms noted above.

### DESCRIPTION OF PREFERRED EMBODIMENTS

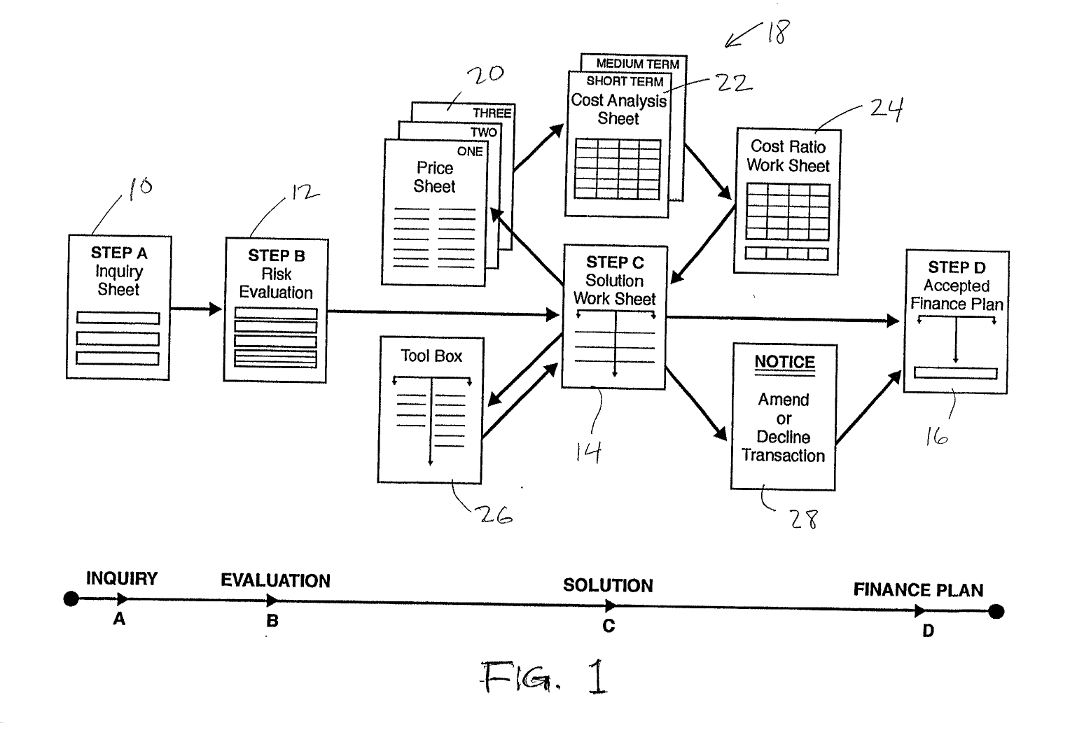

FIG. 1 shows in a flow chart a system for planning the financing of an export transaction, indicating a series of forms.

As noted above, the word “form” as used here is intended to refer to printed forms or forms generated on computer. The principal forms are indicated as Step A, on a form 10; Step B, on a form 12; Step C, on a form 14; Step D, on a form 16. As indicated in the drawing, the process involved with Step C involves other forms, shown in a small loop 18. These forms are price sheets 20, cost analysis sheets 22, and a cost ratio sheet 24. Also shown in association with Step C is a financial “tool box” 26 which, as seen below, is a listing of various financial tools which can be used to arrive at a solution on the solution worksheet of Step C.

The drawing also shows a notice 28 springing from Step C, which essentially comprises an offer of terms to the customer/exporter, based on the solution worked out and set forth on the form 14.

If the customer/exporter accepts the terms proposed, the system proceeds to Step D, on the form 16, which comprises an agreement between the lending officer and the customer/exporter for an accepted finance plan for the export transaction.

The term “lending officer” or “lender” is often used herein.

This should be taken to apply equally to the customer/exporter himself (unless specifically indicated otherwise), since the process can be used by the exporter to determine for himself a financing plan, which can then be taken to a lender as a proposal to the lender. In that case the notice form 28 would be used with the lender.

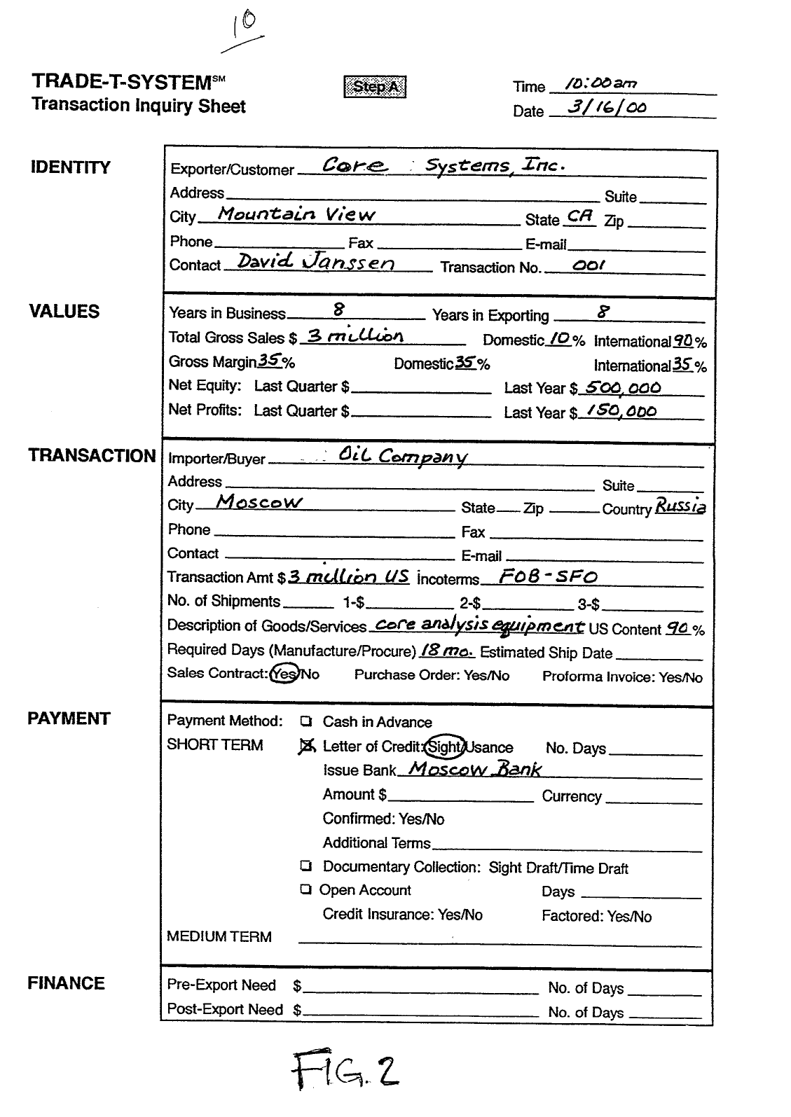

The various forms are explained in greater detail in the succeeding drawing figures. The form 10 of Step A is shown in FIG. 2, with some exemplary information entered. Step A is a transaction inquiry sheet in which the lending officer enters all needed information regarding the customer/exporter. This includes identity as indicated, basically name, address, etc.; values, basically representing the track record of the customer, the customer's size and experience in exporting, etc., as indicated; the transaction, meaning the projected buyer of the exported goods, with information concerning the buyer and including incoterms (where delivery is accepted for purposes of risk of loss); payment, meaning the type of instrument and institution as indicated; and finance, meaning the amount that will need to be financed for the export transaction, broken down into pre-export need and post-export need.

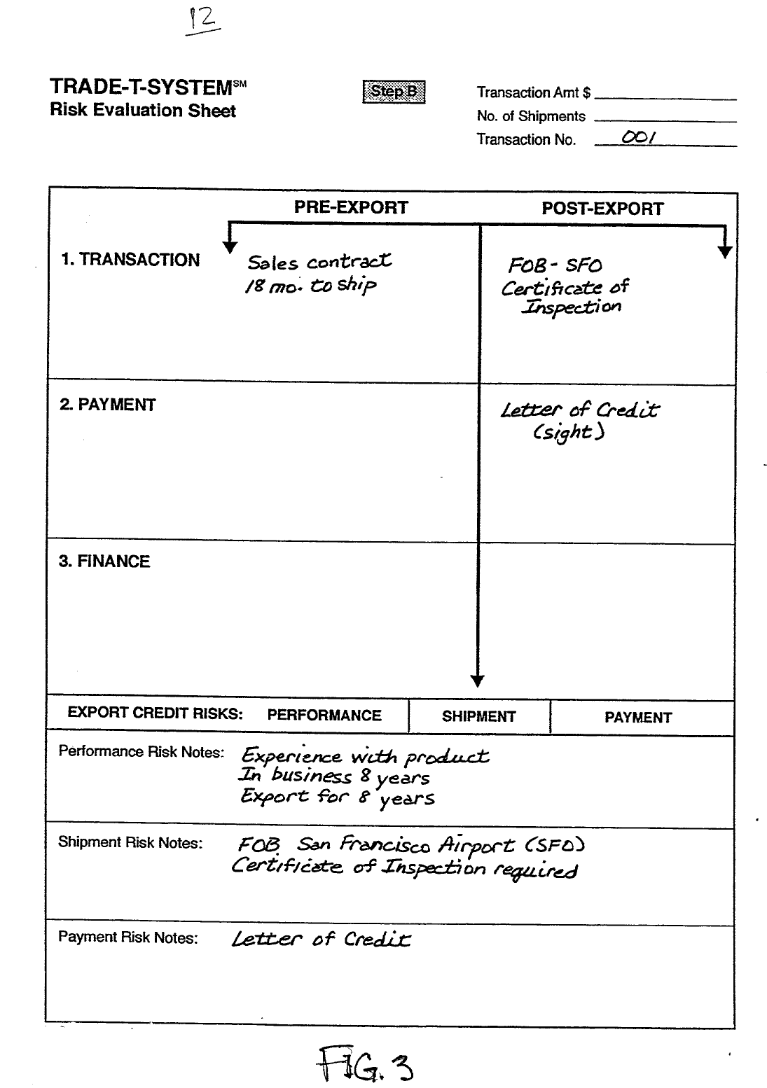

On Step B, the form 12 shown in FIG. 2, the user of the system transfers the transaction payment and finance information onto this form, which is divided into pre-export events, instruments and considerations and post-export events, instruments and considerations. With this form and step, the lending officer (or the exporter himself) seeks to evaluate all risks which could potentially affect the transaction. As noted on the form in FIG. 3, the user is encouraged to enter notes regarding performance risk, meaning risks that the manufacturer/exporter/customer will not perform adequately. Thus, on this form the manufacturer/exporter's experience with the product, business track record and export track record are entered, in this case indicating the exporter to be reliable based on experience.

Notes are also entered regarding shipment risk. In the example illustrated, the incoterms are FOB San Francisco Airport, meaning risk of loss passes to the buyer once the exported products are delivered to that point. A certificate of inspection will be required for this transaction, certifying that the goods are manufactured as promised, for the benefit of the buyer. Payment risk notes are also entered on the form; here a letter of credit is indicated, and the lending officer and the customer will be able to evaluate what risks might be attendant to the letter of credit, and the institution with which it is generated.

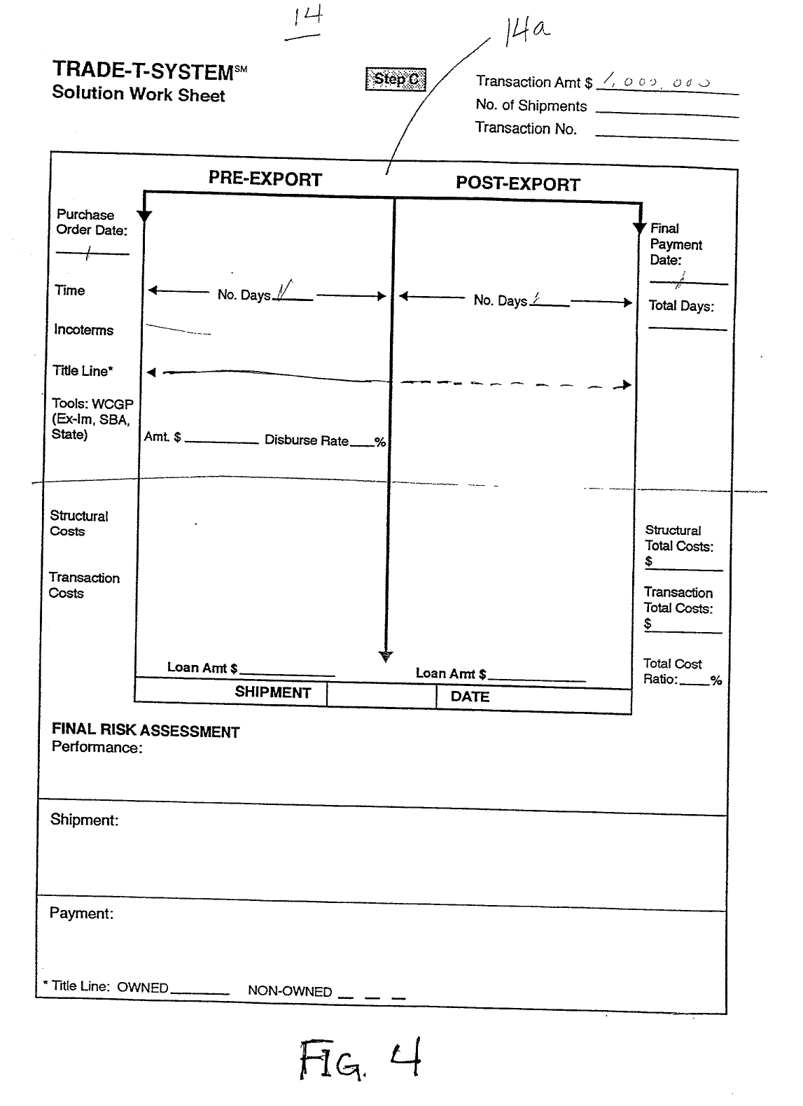

FIG. 4 shows the form 14 for Step C, the solution work sheet. Use of this form and step follows complete assessment of the risks, pre-export and post-export, pursuant to Step B. In Step C the user enters information and works out a solution, i.e. a plan for financing this particular export transaction. First, germane information is entered in the upper portion of the T-shaped form, the “T” dividing the form into pre-export and post-export. Purchase order date, time duration, incoterms, title line (where title and risk of loss are transferred), and selected financing tools are entered in this upper portion of the form, divided into pre-export and post-export. Final payment date is entered at the end of the post-export.

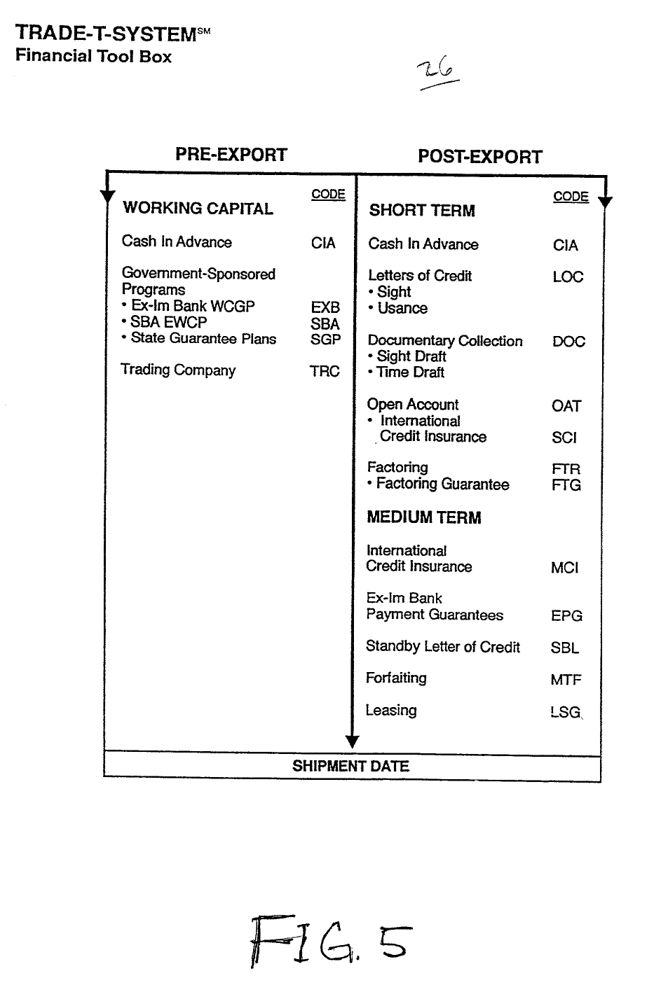

The lower portion of the chart 14a in Step C is used for entry of information/data after the user has performed the auxiliary steps shown in FIG. 1 in association with Step C. The user consults a financial tool box as shown at 26 in FIG. 5, for sources of working capital to finance the pre-export phase, and for sources of financing in the post-export phase, for short term transactions (under one year) or medium term transactions as indicated. As shown in FIG. 5, the list of financial tools for providing working capital to the customer/exporter to produce the goods prior to export includes cash in advance, loans pursuant to government-sponsored programs and trading companies which specialize in such financing. The government-sponsored programs include export-import bank WCGP loans, SBA EWCP loans and state guarantee plans. Other financing tools are possible in some plans.

Post-export, the financing tools for short terms transactions include cash in advance, letters of credit (sight or usance), documentary collection (sight draft or time draft), open account, which can be international credit insurance, and factoring. For medium term transactions, the tools include international credit insurance, Ex-Im bank payment guarantees, standby letter of credit, forfating, and leasing. The user of the system reviews the list of financial tools 26 for appropriate financing tools based on the particular circumstances of this transaction. Appropriate financing tools are selected for pre-export and post-export, and they are entered in the form 14a. The selection is based on risk factors from the preceding risk evaluation, practical considerations such as political and country risk regarding the location of the exporter's buyer, financial considerations within that country, the strength of the exporter's credit, and the amount of cash in advance, if any, but equally important are selection factors such as:

marketing strategies and competitive pressures which can differ for each country or market

better credit enhance the transaction in order to encourage the lender to even provide financing

assist the importer/buyer with acceptable payment teams in order to win the deal

In selecting the tools, the user is choosing appropriate ways to be paid, and investigating working capital options.

From the selection of these tools, the user can then enter the projected costs of financing the export transaction, and, pursuant to an important feature of the system, these are divided into allocated structural costs, and transaction costs. In Step C, the total cost ratio is projected as a percent of the transaction amount representing cost of financing the total transaction against amount of money financed. There are a number of different costs involved, different costs with different finance tools. The actual interest rate normally plays only a small part in the total cost of the export financing transaction. As a very general rule, the total cost ratio should be approximately in the range of 3% to 6%. However, this figure will vary with unusual situations.

Also in Step C, the user can enter information pursuant to a final risk assessment. These are the same risk factors as listed in the form 12 of Step B shown in FIG. 3, but Step C provides for an updating of the risk assessment based on the particular finance tools selected, along with other performance and payment risk factors which may come to light in planning the transaction.

The completion of Step C enables the user of the system to display and evaluate the export financing plan. The total cost ratio is a good indicator as to whether the overall costs are within a reasonable range, and if not why not, providing an important financial measuring and management barometer.

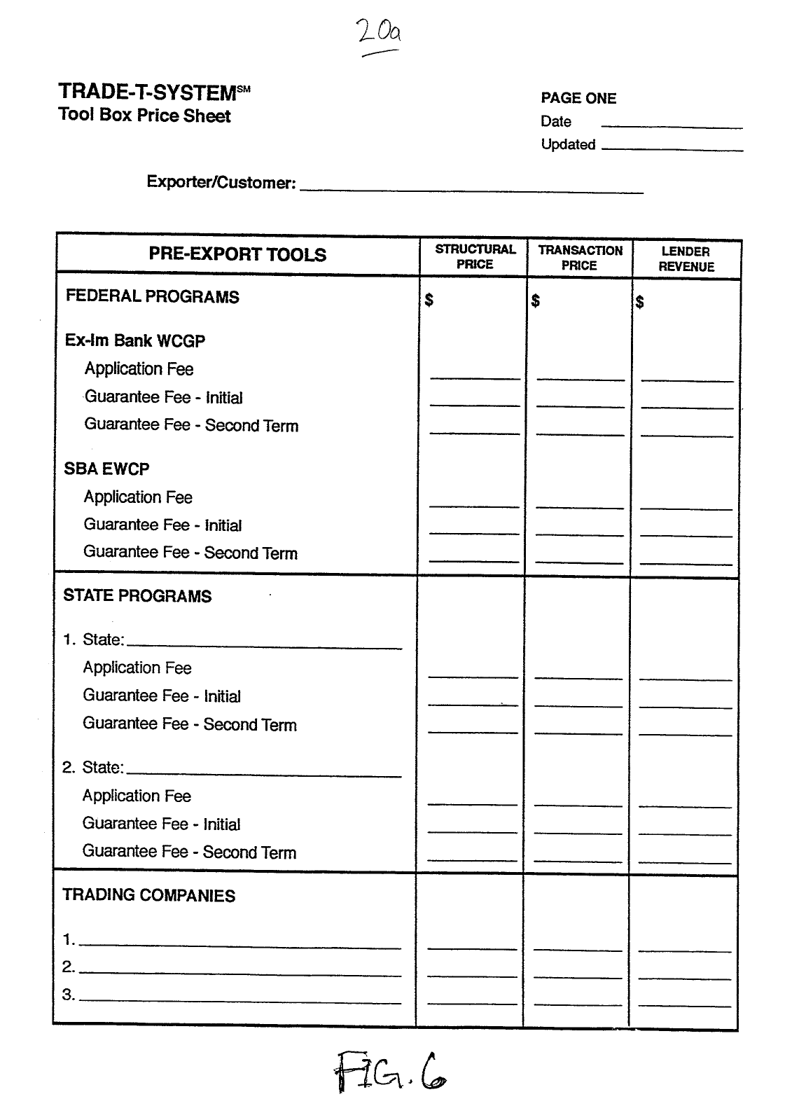

As shown in FIG. 1 and discussed above, the development of a financing solution pursuant to Step C involves a loop indicated at 18, involving forms 20, 22 and 24. These are shown in FIGS. 6, 7, 8, 9 and 10. In conjunction with selecting finance tools from the list of financial tools 26 in FIG. 5, the user consults a tool box price sheet, which is in the form of pages 1, 2 and 3 on FIGS. 6, 7 and 8. This encompasses pre-export tools and post-export tools for both short term and medium term transactions. The form 20a in FIG. 6, page 1 of the tool box price sheet, or financial tool price sheet, outlines typical fees associated with various type of pre-export working capital. These forms, and the loop 18 shown in FIG. 1, represent important costing steps for the transaction. Importantly, these forms provide for itemization of structural cost and transaction cost, as well as lender revenue, which is included in structural and transaction costs but broken out separately. The structural cost will be an allocation of a cost which normally is a one-time charge that might cover a number of different transactions within a given period, such as one year. The user must provide an allocation of such a structural price to arrive at the structural cost attributable to this particular transaction. As an example, a guarantee fee under an Ex-In bank WCGP or under an SBA EWCP would ordinarily be pursuant to a one year guarantee, and this total fee should be allocated, possibly on an estimated basis, over the total number of transactions to which the one year guarantee might apply.

The lending officer enters lender revenue in the right column of the sheet 20a shown in FIG. 6, which becomes a part of the total cost to the exporter/customer.

Trading companies are also indicated in the form 20a, and the user of this system will be familiar with the various fees and costs of these trading companies, or the companies can be consulted for this information.

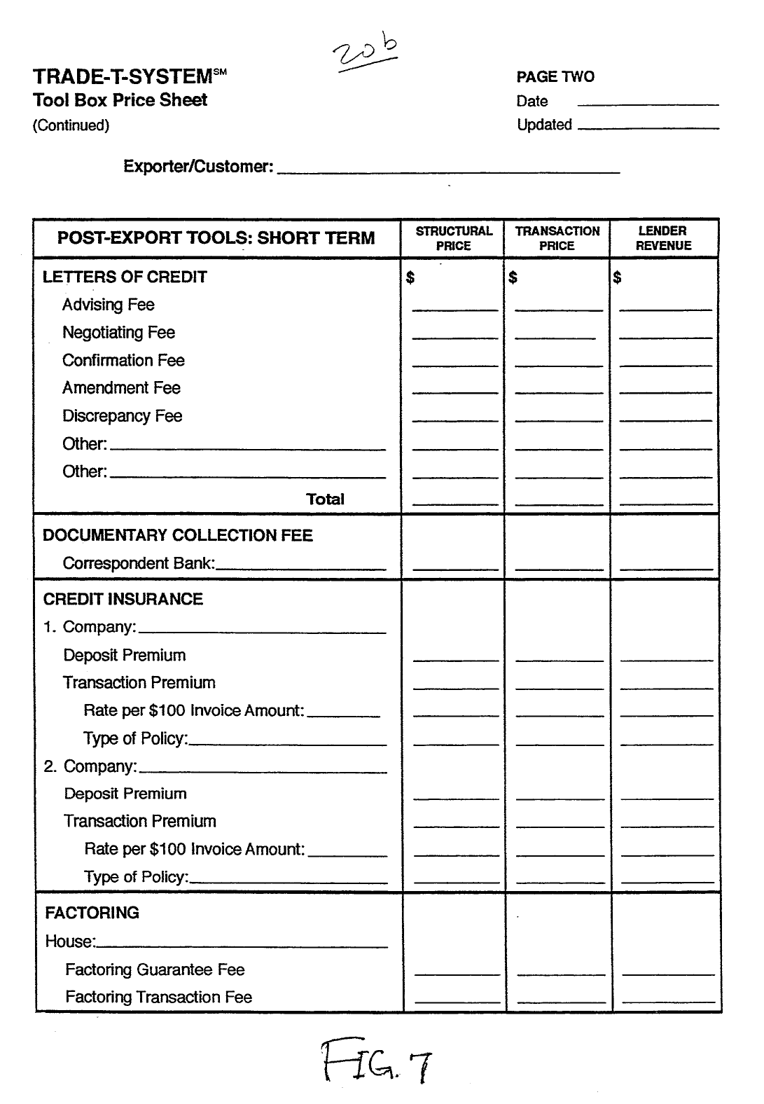

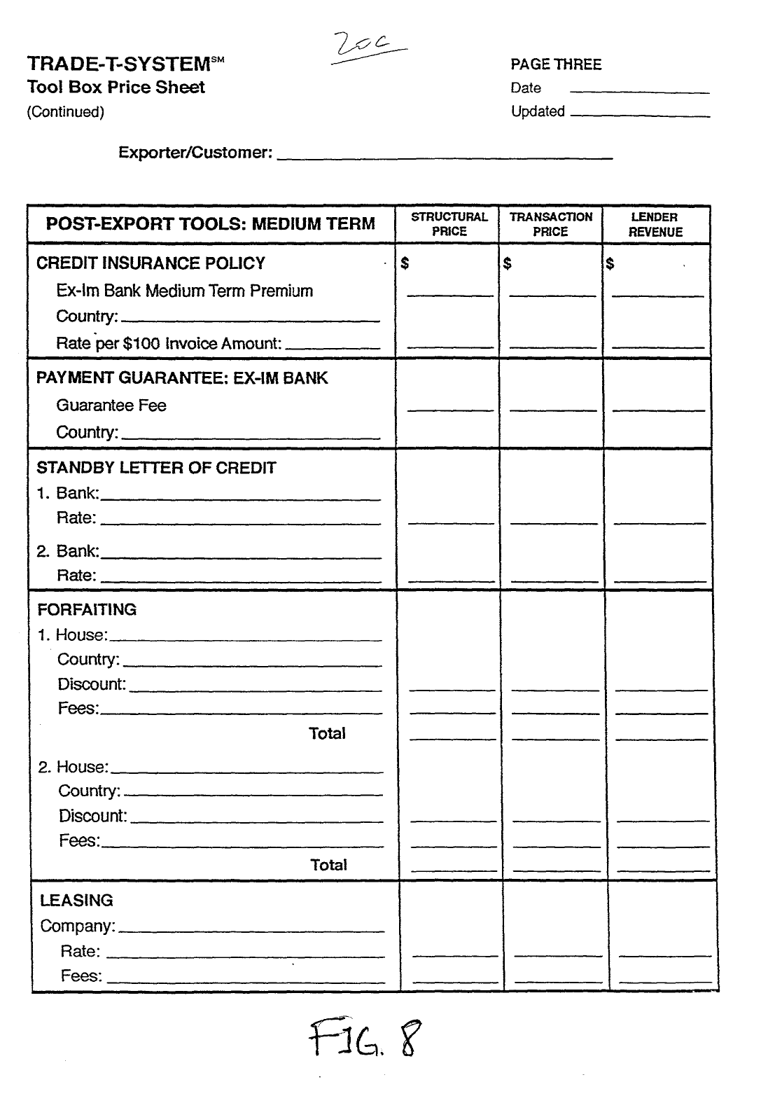

Pages 2 and 3, sheets 20b and 20c shown in FIGS. 7 and 8, provide for costing of post-export financing tools, both short term and medium term. The three sheets 20a, 20b and 20c can be considered as three related forms, or as three pages of a single form. Again, these costs are itemized by structural price, transaction price and lender revenue. As can be seen from FIGS. 7 and 8, the post-export finance tools vary somewhat between short term and medium term transactions. Also, the costing forms create a checklist of various cost in essence a constant reminder thus helping to avoid any overlooked costs. In addition, the cost forms reflect all the detail cost sources providing an easy reference when analyzing why a cost ratio is not within the average 3E to 6E average range.

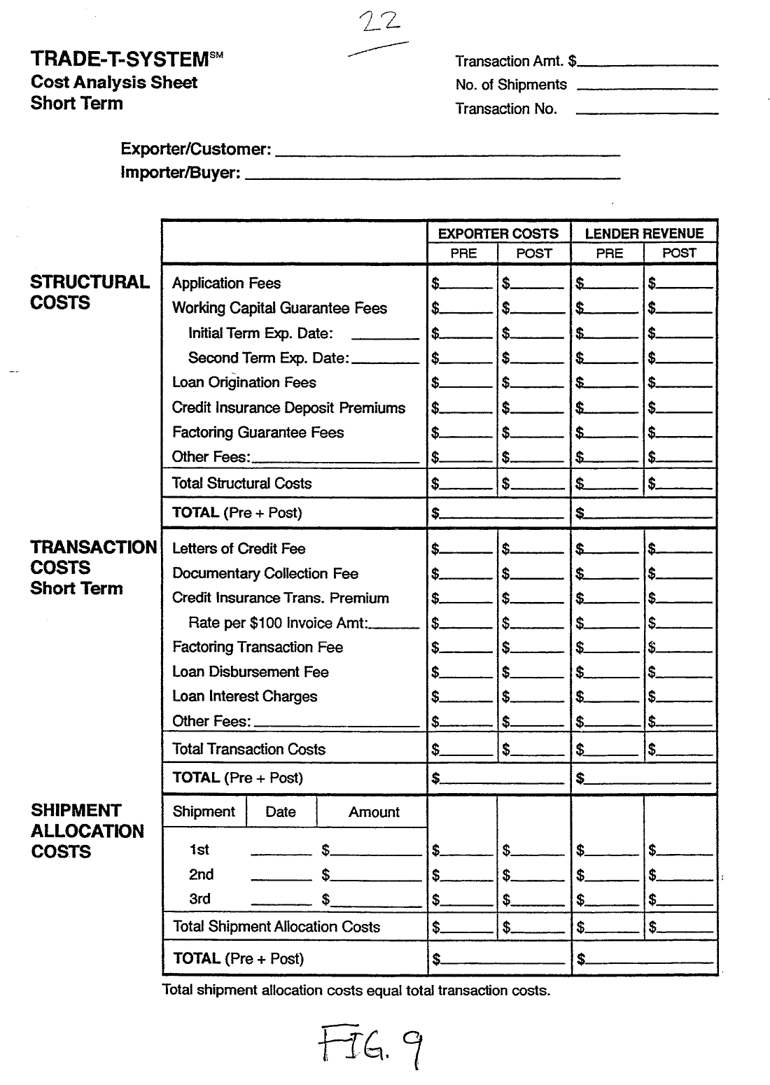

FIG. 9 shows the cost analysis sheet 22, for a short term transaction. The form 22 enables the user to organize the costs entered in the forms of FIG. 6 and FIG. 7 or 8, totaling these costs as structural costs and separately as transaction costs, and with pre-export and post-export itemization. This simply gives the user of the system an orderly manner of summarizing the costs entered on the sheets shown in FIGS. 6-8, reflecting the fees and costs of those financing programs which are actually being selected, or tentatively selected. In addition, the cost analysis sheet 22 provides for shipment allocation costs, where the shipment of goods will be divided into multiple separate shipments, with allocation of the costs at the point of each shipment. The total shipment allocation costs will equal the total transaction costs.

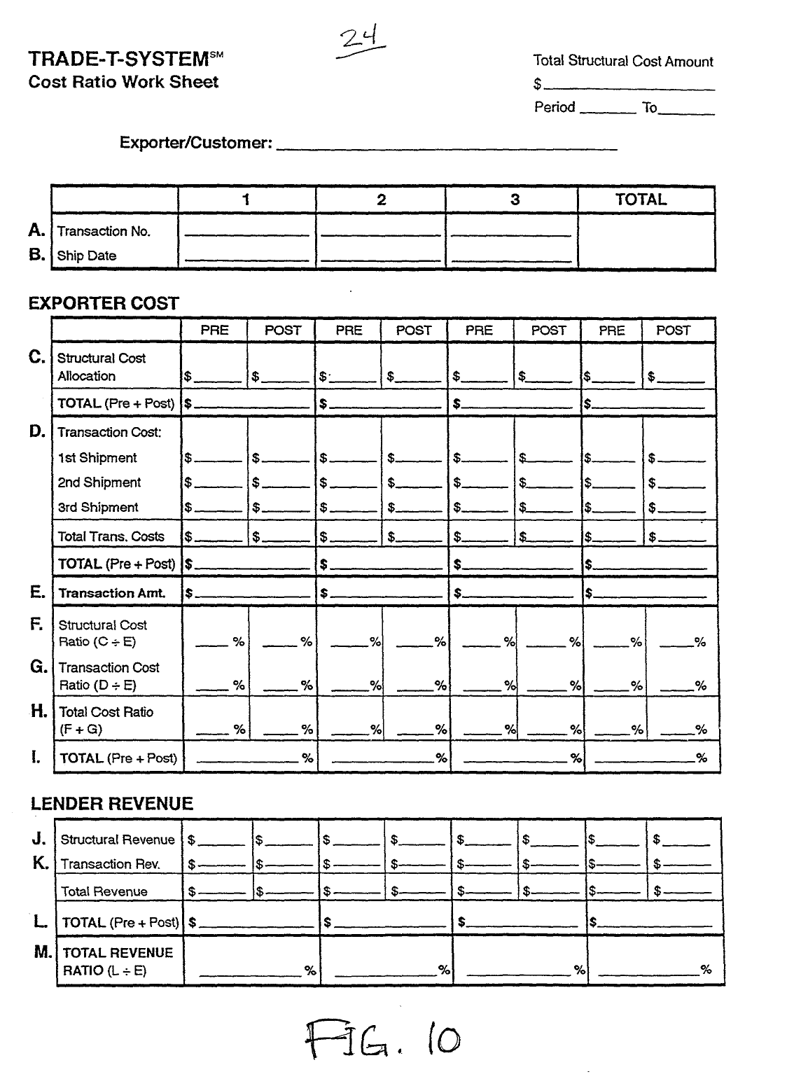

FIG. 1 also shows a cost ratio worksheet 24 as part of the costing loop 18, and this form 24 is shown in FIG. 10. The cost ratio work sheet 24 breaks down and itemizes exporter cost. Lender revenue is included in exporter cost, but is also itemized separately. This is the case with all of FIGS. 6-10. The goal of the cost ratio work sheet 24 is to arrive at a total cost ratio for each projected finance transaction, of which there may be many for the particular customer (space for entry of three transaction is shown, but the form could be expanded to embrace a large number). Provision is made for totaling structural and transaction costs for all transactions, in the “TOTAL” column. In line I, the total cost ratio will be entered, for each transaction and for the total. The lender can also enter items of revenue in the “LENDER REVENUE” box, arriving at a total revenue ratio at the lower right of the form, i.e. total revenue as a proportion of the amount of money financed.

The total cost ratio is entered on the solution work sheet 14, Step C, FIG. 4. Structural total costs and transaction total costs are also entered, as indicated on the right side of the form 14a. This can be for one transaction or a series of projected transactions for the customer. As noted above, this total cost ratio, as well as the total of structural costs and the total of transaction costs, are important factors for the lending officer and/or the exporter/customer to determine whether the plan for financing the transaction is reasonable and sound. If not, the lender or the exporter can do further iterations of the overall Step C process, including use of the financial tool box 26 and the costing loop 18, in an attempt to arrive at an acceptable solution.

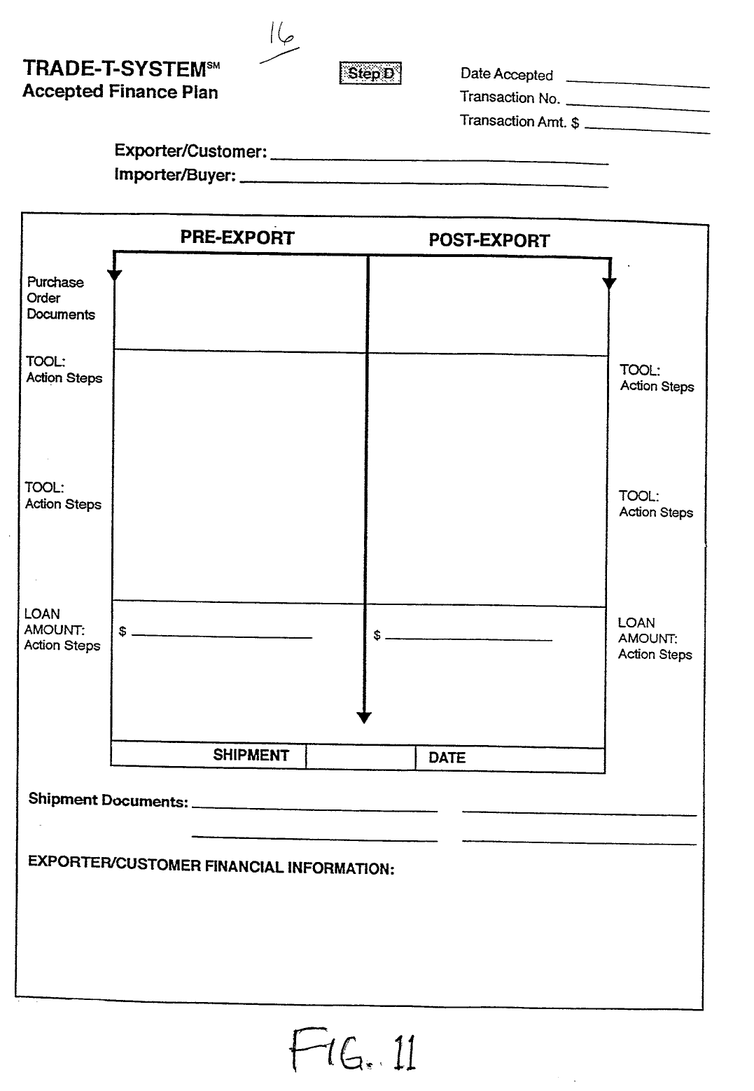

As outlined in FIG. 1, once the lending officer has arrived at what appears a workable solution pursuant to Step C, the terms are presented to the exporter/customer as in the box 28 in FIG. 1, who either negotiates changes or declines the transaction. If accepted, the parties proceed to Step D, an accepted finance plan which constitutes a term sheet that will be the basis for documents to be prepared for an agreement between the lender and the exporter/customer. The accepted finance plan is shown at 16 in FIG. 1 and in FIG. 11, and will contain all indicated information as in FIG. 11, outlining the financing tools, both pre-export and post-export, and all action steps to be taken along the timeline of the transaction. Loan amounts are entered, both pre-export and post-export as indicated. Financial information of the exporter/customer is entered near the bottom of the form 16 as indicated.

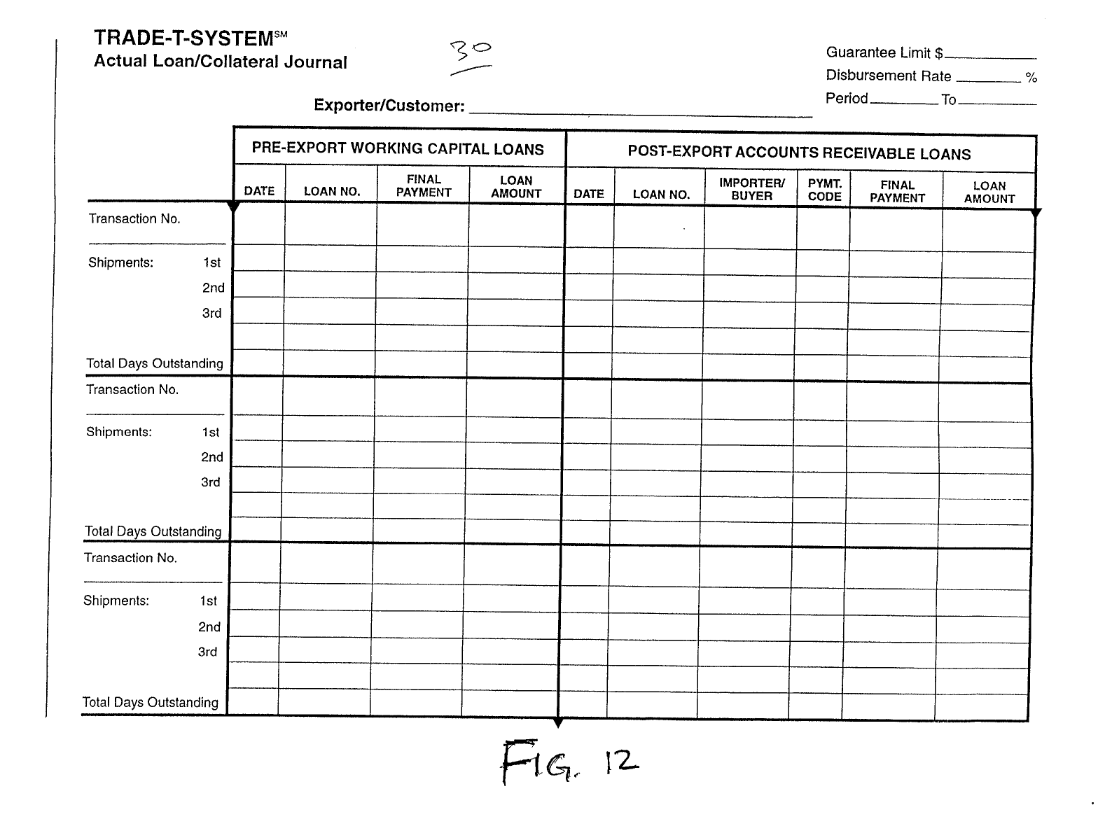

The remaining drawings relate to entry of actual events and amounts as they occur during the transaction and after the conclusion of the transaction. FIG. 12 shows a form 34 for collateral management, in a series of export transactions for the same customer. The purpose is for the lending officer to maintain a record of the status of collateral and monitor the outstanding aggregate amount of loans for this customer.

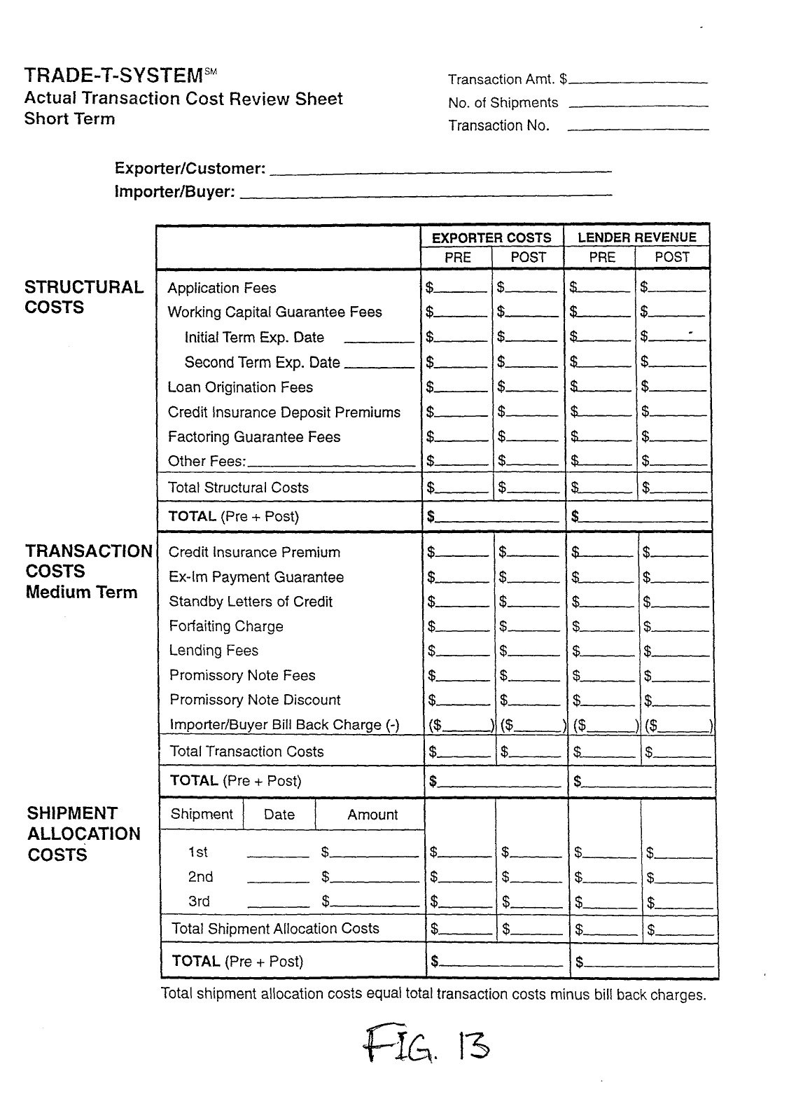

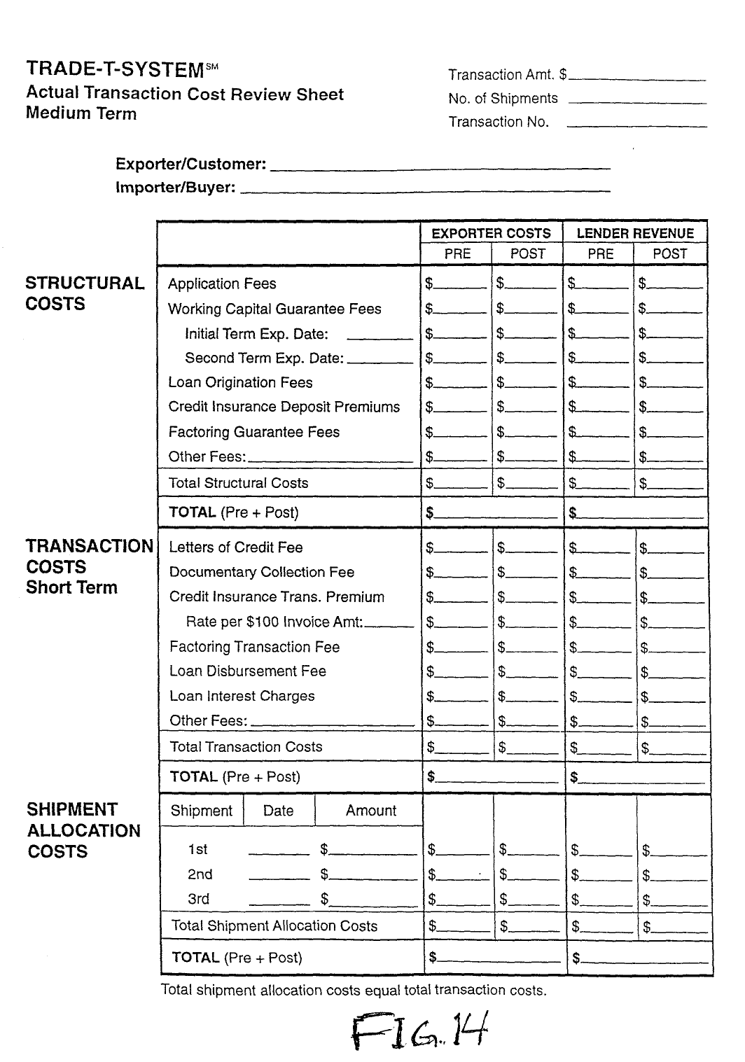

View 13 shows a form 35 for actual transaction cost review. This form is the same as the cost analysis sheet 22 of FIG. 9, but it prompts the lending officer to record actual costs which were incurred for each transaction, after which these actual costs can be compared with the projected costs of the virtual transaction in the cost analysis sheet of FIG. 9. FIG. 13 shows a form 35 for a short term transaction, while FIG. 14 shows a form 36 for a medium term transaction, with somewhat different entries than in the case of a short term transaction. A similar form can be provided at the cost analysis stage.

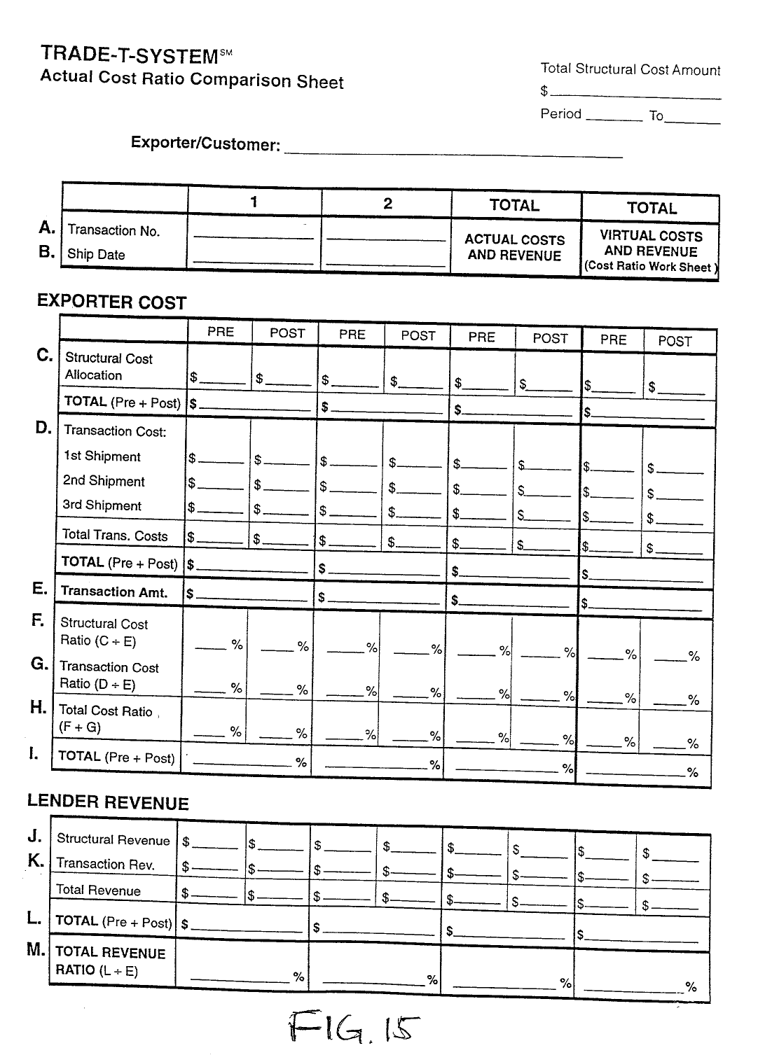

FIG. 15 is a form 38 comprising an actual cost ratio comparison sheet. This form is structured similarly to the cost ratio work sheet shown in FIG. 10, but with two “TOTAL” columns, one for actual costs and revenue and the other for the virtual costs and revenue which were entered in the cost ratio work sheet of FIG. 10. The form can receive entry of as many transactions as desired, space for two transactions being shown on the form in FIG. 15. Thus, the total columns can be used to evaluate a series of transactions in the aggregate. Individual total cost ratios (actual) are shown in the columns “1” and “2” at line I. Again, as in FIG. 10, the lender revenue section at the bottom has actual figures which comprise a part of the cost figures listed above. The form 38 of FIG. 15 takes information from FIG. 10, the cost ratio work sheet 24, and from FIG. 13, the actual transaction cost review sheet 35, for purposes of comparison.

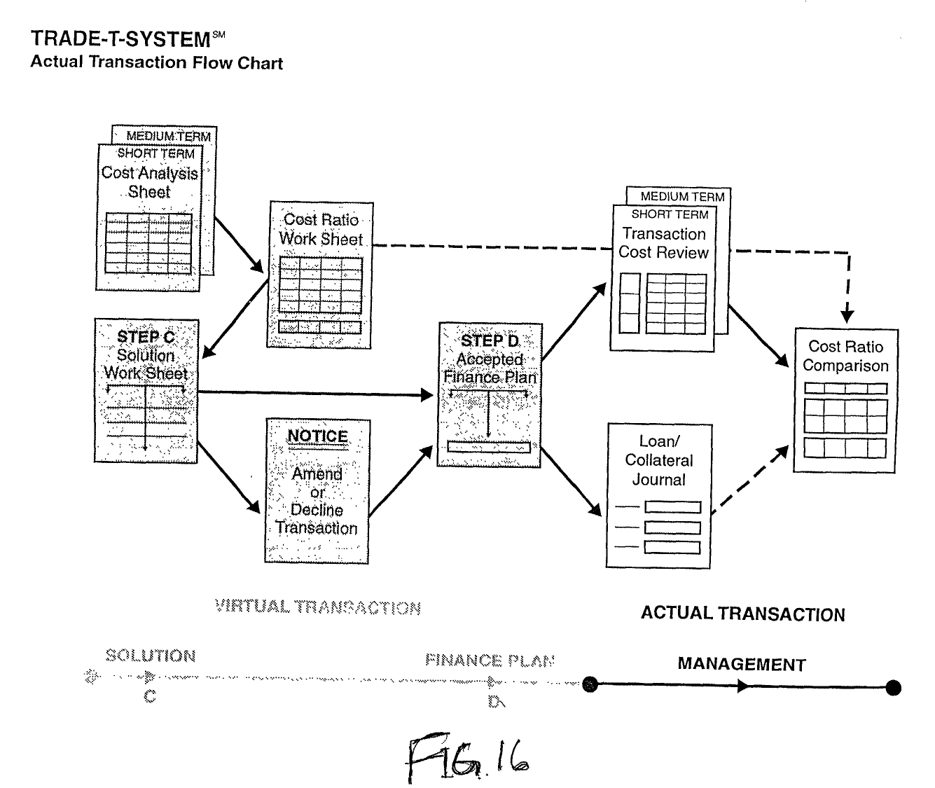

FIG. 16 shows the virtual transaction as compared to the actual transaction, with real figures. This shows flow from the point of Step C, the solution work sheet in the virtual transaction, through the actual transaction, with the forms 30, 35, 36 and 38 shown.

The above described preferred embodiments are intended to illustrate the principles of the invention, but not to limit its scope. Other embodiments and variations to this preferred embodiment will be apparent to those skilled in the art and may be made without departing from the spirit and scope of the invention as defined in the following claims.

I claim:

1. A method for use in gathering, evaluating, planning and estimating risks and costs of financing an export transaction, comprising:
(a) entering onto an inquiry form information concerning an exporter/customer and concerning the transaction to be financed, including information regarding the exporter/customer, information on the buyer in the proposed transaction, and information on the goods to be sold, terms of sale and the price to be paid for the goods to be exported to the buyer, and the time frame for delivery; and also entering method of payment information and information concerning the financing needed for the transaction,
(b) evaluating risks of the transaction, both pre-export and post-export, including risks attendant to the nature of the particular transaction and to the point at which risk of loss passes to the buyer, risk involved in obtaining payment to the exporter/customer, and risks attendant to financing of the entire transaction,
(c) entering information into a solution work sheet divided into pre-export and post-export time and events, the entered information including the time duration between initiation of the transaction and shipment, and the time duration from shipment until projected final payment for the goods exported, incoterms for the transaction, and the time at which risk of loss passes to the buyer,
(c1) using a list of financial tools to review possible pre-export and post-export credit tools for financing the export transaction,
(c2) entering information on a financial tool price sheet, as to the structural cost and the transaction cost of using each of a plurality of pre-export tools listed on the list of financial tools, and a plurality of post-export tools listed on the list of financial tools, and determining lender revenue for each of the various alternatives,
(c3) selecting appropriate financing tools for the transaction, both pre-export and post-export, and entering projected structural costs and transaction costs on the solution work sheet as tentative costs for a course of action using the selected tools,
(c4) calculating total structural costs and total transaction costs for the transaction, adding such costs and determining a total cost ratio for the financing of the transaction, calculated as total costs including structural and transaction costs, divided by the total transaction amount, the total cost ratio serving as a cost management device and a cost tracking mechanism, and
(c5) evaluating the overall cost ratio, and if it appears reasonable for the transaction, preparing a term sheet which contains a finance proposal for the export transaction.

2. The method of claim 1, including, if the customer/exporter and a lender agree on the finance proposal, preparing an accepted finance plan, including action steps and dates and outlining the pre-export and post-export portions of the transaction and giving the lender basis for a written financing offer.

3. The method of claim 1, wherein the step of evaluating risk of the transaction includes entry of all pertinent information on a risk evaluation sheet divided into pre-export and post-export sections.

4. The method of claim 1, further including, if the total cost ratio seems unacceptable for the transaction, reiterating steps c1 through c5 using different financial tools from the list of financial tools, with entry of different costs onto the solution work sheet, in an attempt to obtain a better total cost ratio.

5. The method of claim 2, further including an additional step (d) of entering information on actual costs of the financing transaction as the transaction goes forward, onto a cost comparison sheet on which actual items of cost and actual total cost can be compared against costs determined in steps c2 through c5.

6. The method of claim 5, additionally including calculation of an actual cost ratio and comparing the actual cost ratio to the overall cost ratio determined pursuant to step c4.

7. The method of claim 6, including entry of actual information on an actual transaction cost review sheet itemized as to exporter costs, both pre-export and post-export, with lender revenue broken out separately, and including entry of actual costs and revenue as determined from the actual transaction cost review sheet onto an actual ratio comparison sheet, and further entering projected costs and revenue onto the actual cost ratio comparison sheet, and comparing the actual and projected costs and revenue, including comparison of actual and projected overall cost ratio for the transaction.

8. The method of claim 1, performed by a lender, and wherein Step (b) includes evaluating performance risks of the exporter/customer, related to the payment record of the exporter/customer.

9. A system for use by a lender and financer of exports or by an exporter for evaluating, planning and estimating costs of financing and export transactions, comprising:
(a) an inquiry form with prompts for entry of information regarding the identity of the exporter/customer, information concerning the exporter/customer's business, information concerning the particular export transaction to be financed, including the buyer, the transaction amount, incoterms and description of goods or services, and method of payment to be used,
(b) a risk evaluation form with prompts for entry of information affecting risks, both pre-export and post-export,
(c) a solution work sheet divided into pre-export and post-export time and events, with prompts for entry of information including the time duration between initiation of the transaction and shipment, and the time duration from shipment until projected final payment for the goods exported, and the time at which risk of loss passes to the buyer,
a list of financial tools with a plurality of potential pre-export tools or sources of working capital and a plurality of post-export tools or sources of financing,
a financial tool price sheet with prompts for entry of cost information, both structural cost and transaction cost for a plurality of different pre-export tools listed on the list of financial tools and a plurality of post-export tools listed on the list of financial tools,
a cost analysis sheet with prompts for entry of projected exporter costs, itemized and listed as to structural costs or transaction costs, and for entry of projected lender revenue,
a cost ratio work sheet with spaces and prompts for entry of total projected structural costs and transaction costs for the transaction, and for calculating a total cost ratio projected for the transaction.

10. The system of claim 9, wherein the cost ratio work sheet includes spaces and prompts for entry of projected lender revenue and a projected total lender revenue ratio.
